(19) United States
(12) Patent Application Publication
(10) Pub. No.: US 2016/0187895 A1
(43) Pub. Date: Jun. 30, 2016

(54) APPARATUS, SYSTEM AND METHOD FOR CONSERVING WATER

(71) Applicants: Shai BRENNER, Haifa (IL); Eyal ATTIA, Ramat Gan (IL)

(72) Inventors: Shai BRENNER, Haifa (IL); Eyal ATTIA, Ramat Gan (IL)

(73) Assignee: AQUA-TECHSYSTEMS LTD., Misgav (IL)

(21) Appl. No.: 13/521,798

(22) PCT Filed: Jan. 13, 2011
(86) PCT No.: PCT/IL11/00044

§ 371 Date: Dec. 10, 2012

Related U.S. Application Data
(60) Provisional application No. 61/294,516, filed on Jan. 13, 2010.

(51) Int. Cl. G05D 23/185; F24D 19/10; F24D 17/00

(52) U.S. Cl. CPC G05D 23/1858; F24D 17/0078; F24D 19/1051

(57) ABSTRACT

Provided herein is a water saving apparatus configured for purging water from a hot water supply line into a cold water supply line comprising a hot water cavity connected to said hot water supply line for allowing flow of water from said hot water supply line to said first cavity; a cold water cavity connected to said cold water supply line for allowing flow of water from said cold water supply line to said cold cavity and from said hot water cavity to said cold water supply line; a valve configured to block the flow of water between said hot water cavity and said cold water cavity in a first position thereof and to allow the flow of water from said hot water cavity through said cold water cavity and to said cold water supply line in a second position thereof for purging water from said hot water supply line.

### FIELD OF THE INVENTION

The present invention relates to the field of water conservation systems. More particularly, the invention relates to an apparatus for circulating water flowing in the hot water pipes until the water is warm.

### BACKGROUND

Many household hot water systems use a central storage-tank type water heater. Each such heater comprises a device for heating the water, and an insulated storage tank for the heated water. A typical household heating tank is equipped with a single storage tank heater from which hot water is piped to the various locations in the house. When hot water is not drawn from the central storage-tank type water heater, the pipes, with the water in them, leading from the heater, cool to the temperature of the surrounding environment, the ambient temperature. When a user opens a hot water faucet, water is received at the ambient temperature. Hot water of the desired temperature only reaches the faucet after the cooled water is removed from the pipes, and enough hot water has flowed through the pipes to warm the pipes.

The initial water drawn from the hot water faucet, the cooled water at ambient temperature, is often wasted. Before taking a shower, a user will typically turn on the hot water faucet, allowing the received potable water to run down the drain in waste. When the water at ambient temperature is purged from the pipes, and hot water reaches the faucet, the user will adjust the temperature and enter the shower. Other users may turn on the hot water, allowing potable water to flow down the drain, while performing some unrelated task. Sometime later, after hot water has reached the faucet, the user will return to the shower, adjust the temperature, and begin the shower. This not only wastes potable water and energy related to water heating, but also increases the load on the sewage system being used because of the increase in volume of liquid sewage to be treated.

According to some embodiments, a family of four people may waste more than 3 cubic meters of water a month waiting for hot water for a shower, for shaving, for washing dishes, etc. A larger family will waste even more potable water. It is therefore advantageous if the loss of this water can be prevented.

The amount of water wasted while purging hot water pipes can be reduced through use of a demand-type water heater located close to the faucet. Multiple demand-type water heaters are often required if water wastage is to be eliminated because the various faucets are not always located close to each other. Further, demand-type water heaters are usually electric water heaters and are significantly less efficient than natural gas fired heaters of the storage tank type.

Another method for reducing the amount of water wasted while purging pipes is the continuously circulating hot water systems. With these systems, the pipes leading from the hot water heater are arranged in a loop, passing near each faucet, with a return pipe to the hot water heater. A pump is inserted in the loop to keep hot water flowing through the loop, thereby keeping the pipes and the water in them at a high temperature. This system is not energy efficient because of the heat transfer from the pipes to the environment and the energy wasted in water circulation. Such a system is also difficult to retrofit to existing buildings. This system is nonetheless common in large buildings with many bathrooms such as hospitals or hotels.

U.S. Pat. No. 5,277,219 shows a water saving system wherein an electric pump is used to pump ambient temperature water from the hot water pipe into the cold water pipe. A switch is pressed to turn on the pump when hot water is desired. The pump turns off when a temperature sensor detects that the cool water has been purged from the hot water pipe. A similar system is portrayed in U.S. Pat. No. 5,105,846 in which a timer shuts off the electric pump. Yet another such system is portrayed in U.S. Pat. No. 5,009,572. Nevertheless, such systems are somewhat complex to install, maintain, and operate.

There is still a need in the art for water conservation systems that would allow better saving of water and energy.

### SUMMARY OF THE INVENTION

It is an object of the present invention to provide an apparatus for reserving the cooled water in the hot water supply line.

It is another object of the present invention to provide hot water (or water at a predetermined temperature) per demand (for example, per demand of a user) without providing cold or not sufficiently warm water first. According to some embodiments, the apparatus is adapted to purge the hot water supply line from cold or not sufficiently warm water prior to allowing the water to be available to the user. The Apparatus thus facilitates saving water and energy. According to some embodiments, the apparatus and methods of the present invention, are adapted to purge the hot water supply line from cold or not sufficiently warm water by directing the cold or not sufficiently warm water to the cold water supply line, per demand. According to some embodiments, the apparatus and methods of the present invention, allow a user to control the apparatus and decide if and when to activate the purging of the hot water supply line from cold or not sufficiently warm water, as per his/her needs, habits, requirements, or the like. For example, a user may decide to activate (by using the activator) the purging of the hot water supply line prior going into the shower or the user may decide to automatically activate the purging of the hot water supply line every predetermined period of time. The user may also decide to stop the purging of the hot water supply line at any time for example if no hot water are available at all. The activator may be configured for manual or automatic operation. For example, the activator may be configured to automatically stop purging the hot water supply line upon detection that no hot water are available, for example after a predetermined period of time when no hot water were sensed. According to some embodiments, the apparatus may be configured to be positioned at any location (for example, between a hot water supply line and to a cold water supply line) and to be connected to the hot water supply line and to the cold water supply line. The apparatus may be positioned adjacent to a water faucet or remotely from one or more water faucets.

It is still another object of the present invention to provide a method for reserving water, for example in households, industrial facilities, hospitals, offices and the like, without requiring a complex modification to the household water supply system.

Other objects and advantages of the invention will become apparent as the description proceeds.

According to some embodiments, there is provided an apparatus comprising a valve (for example, a thermostatically controlled valve) comprising an actuator (for example a thermally sensitive actuator) configured to bypass water from a hot water supply line to a cold water supply line

until a certain condition is reached (for example the temperature of the water is at a predetermined value). The apparatus further comprises an activator configured to allow a user to control the valve and thus control the beginning and/or ending of the bypassing of water from the hot water supply line to the cold water supply line.

According to some embodiments, there is provided an apparatus for purging water from a hot water supply line into the cold water supply line comprising:

a first water port (for example, first water port 20) connected to the hot water supply line, for allowing flow of water from the hot water supply line to the apparatus;

a second water port (for example, second water port 10) connected to the cold water supply line for allowing flow of water from the first water port to the cold water supply line, and or from the cold water supply line to the apparatus;

a valve configured to stop the flow of water between the first water port and the second water port in a first position thereof and to open allow the flow of water from the first water port through the second water port and to the cold water supply line in a second position thereof for purging water from the hot water supply line;

a mechanism configured to, directly or indirectly, shift the valve from the first position to the second position;

an activator configured to operate the valve.

According to some embodiments, operating the valve by the activator comprises shifting the valve from first position to a second position of the valve and/or from a second position to a first position of the valve.

According to some embodiments, the mechanism comprises a thermal mechanism adapted to change one or more dimensions or form thereof as a function of temperature (for example, expand at higher temperatures and reduce its size at lower temperatures) and as a result actuates another element such as a valve.

According to some embodiments, the valve activating mechanism comprises a manual actuator and a thermal mechanism adapted to move the valve between the two positions.

According to some embodiments, the thermal mechanism, may include a pellet. The thermal pellet may include, for example wax, which may or may not include additives such as metal(s) particles, such as cupper and/or aluminum particles.

In one embodiment, the thermal mechanism may include a bimetal element.

In one embodiment, the mechanism comprises a timer.

The activator may be a button, such as a push button and/or a pull button. In one embodiment, the activator is a cord. In one embodiment, the activator is a switch. In one embodiment, the activator is a lever. In one embodiment, the activator is a chain. In one embodiment, the activator is a push rod.

According to one embodiment, the activator may be configured for manual operation. According to one embodiment, the activator may be configured for automatic operation.

According to one embodiment, there is further provided a system for circulating water from a hot water supply line into the cold water supply line, the system comprising:

an apparatus comprising:

a first water port (for example, first water port 20) connected to the hot water supply line, for allowing flow of water from the hot water supply line to the apparatus;

a second water port (for example, second water port 10) connected to the cold water supply line for allowing flow of water from the first water port to the cold water supply line;

a valve configured to stop the flow of water between the first water port and the second water port in a first position thereof and to open allow the flow of water from the first water port through the second water port and to the cold water supply line in a second position thereof for purging water from the hot water supply line;

a mechanism configured to, directly or indirectly, shift the valve from the first position to the second position; and

an activator configured to operate the valve; and

a water faucet connected to a third and a fourth water ports (such as water ports 21 and 11) of the apparatus. The water faucet may include a Thermal faucet.

According to one embodiment, there is further provided a water saving apparatus configured for purging water from a hot water supply line into a cold water supply line comprising:

a hot water cavity connected to the hot water supply line for allowing flow of water from the hot water supply line to the first cavity;

a cold water cavity connected to the cold water supply line for allowing flow of water from the cold water supply line to the cold cavity and from the hot water cavity to the cold water supply line;

a valve configured to block the flow of water between the hot water cavity and the cold water cavity in a first position thereof and to allow the flow of water from the hot water cavity through the cold water cavity and to the cold water supply line in a second position thereof for purging water from the hot water supply line;

a mechanism configured to, directly or indirectly, shift the valve from the first position to the second position; and

an activator configured to shift the valve from the first position to the second position per demand.

According to one embodiment, there is further provided a water saving faucet comprising:

a water saving apparatus for purging water from a hot water supply line into a cold water supply line, the apparatus comprises:

a hot water cavity connected to the hot water supply line for allowing flow of water from the hot water supply line to the first cavity;

a cold water cavity connected to the cold water supply line for allowing flow of water from the cold water supply line to the cold cavity and from the hot water cavity to the cold water supply line;

a valve configured to block the flow of water between the hot water cavity and the cold water cavity in a first position thereof and to allow the flow of water from the hot water cavity through the cold water cavity and to the cold water supply line in a second position thereof for purging water from the hot water supply line;

a mechanism configured to, directly or indirectly, shift the valve from the first position to the second position; and

an activator configured to operate the valve per demand; and

a mixing valve controlled by a handle, the mixing valve is configured to allow a user to adjust (by the handle) the water temperature and the amount of mixed water exiting the faucet.

According to one embodiment, there is further provided a water saving system comprising:

a water saving apparatus for purging water from a hot water supply line into a cold water supply line, the apparatus comprises:

a hot water cavity connected to the hot water supply line for allowing flow of water from the hot water supply line to the first cavity;

a cold water cavity connected to the cold water supply line for allowing flow of water from the cold water supply line to the cold cavity and from the hot water cavity to the cold water supply line;

a valve configured to block the flow of water between the hot water cavity and the cold water cavity in a first position thereof and to allow the flow of water from the hot water cavity through the cold water cavity and to the cold water supply line in a second position thereof for purging water from the hot water supply line;

a mechanism configured to, directly or indirectly, shift the valve from the first position to the second position; and

a pump configured to increase hot water pressure in the hot water supply line upon indication of a decrease, below a predetermined value, in a differential pressure between the hot water supply line and the cold water supply line.

Such pump may be adapted to operate to increase hot water pressure only when the differential pressure between hot and cold water decreases below a preset value. This way the pump is activated only when needed and energy is saved. The differential pressure may be detected by differential pressure sensor(s) connected to hot and cold water lines.

According to some embodiments, the mechanism may include a thermal mechanism. According to some embodiments, the thermal mechanism may include a pellet. The thermal pellet may include, for example wax, which may or may not include additives such as metal(s) particles, such as cupper and/or aluminum particles. In one embodiment, the thermal mechanism may include a bimetal element.

According to some embodiments, the thermal mechanism may be adapted to shift the valve from the second position back to the first position when the temperature of the water increases to a predetermined value, thereby the flow of water from the hot water cavity through the cold water cavity and to the cold water supply line is stopped.

According to some embodiments, the mechanism may include a timer. The timer may stop the flow of water from the hot water cavity through the cold water cavity and to the cold water supply line after a predetermined period of time.

According to some embodiments, the activator may be configured for manual operation. The activator may be selected from a group consisting of: a button, a cord, a switch, a lever and a chain.

According to some embodiments, the valve may essentially be in a cylindrical shape and wherein the mechanism is a thermostatic working element, the valve is configured to change its position upon a change of temperature of the thermostatic working element and upon activation of the activator by a user, such that: in a first position of the apparatus, the valve blocks water flow between the hot water cavity and the cold water cavity, and upon activation of the activator, in a second position of the apparatus, the valve is positioned to allow water flow between the hot water cavity and the cold water cavity and thus allowing bypassing of water from the hot water supply line to the cold water supply line until water temperature increases to a predetermined value and the apparatus is shifted to a third position, wherein the valve blocks water flow between the hot water cavity and the cold water cavity and the water bypassing is stopped.

According to some embodiments, the valve may essentially be in a hollow cylindrical shape and wherein the mechanism is a thermostatic working element and is located inside the valve, the valve comprises one or more openings, the valve and the thermostatic working element are configured to move (for example, along the length axis of the cylinder) with respect to one another upon activation of the activator and upon a change of temperature of the thermostatic working element, such that: in a first position of the apparatus, the valve blocks water flow between the hot water cavity and the cold water cavity, and in a second position of the apparatus and upon activation of the activator, the valve is positioned with respect to thermostatic working element to allow water flow (through the one or more openings thereof) between the hot water cavity and the cold water cavity and thus allowing bypassing of water from the hot water supply line to the cold water supply line until water temperature increases to a predetermined value and the apparatus is shifted to a third position, wherein the valve blocks water flow between the hot water cavity and the cold water cavity and the water bypassing is stopped.

The third position may be achieved by the extraction of a pin from the thermostatic working element.

According to some embodiments, upon a decrease of water temperature the pin is retracted back inside the thermostatic working element and the apparatus is configured to return to the first position. According to some embodiments, the apparatus further includes a spring configured to starch and facilitate the return of the apparatus to the first position.

According to some embodiments, there is further provided a method for water saving by purging water from a hot water supply line into a cold water supply line using anyone of the apparatuses, faucets and/or systems described herein.

### BRIEF DESCRIPTION OF THE FIGURES

FIG. 1a shows a cross section of a water saving apparatus, set in its first position, according to an embodiment of the invention.

FIG. 1b shows a cross section of the water saving apparatus of FIG. 1a, set in its second position, according to an embodiment of the invention.

FIG. 1c shows a cross section of the water saving apparatus of FIGS, 1a-b, set in its third position, according to an embodiment of the invention.

FIG. 2a shows a cross section of a water saving apparatus, set in its first position, for continuously circulating hot water systems, according to some embodiments of the invention.

FIG. 2b shows a cross section of the water saving apparatus of FIG. 2, set in its second position, according to some embodiments of the invention.

FIG. 3a shows an exploded view of a typical mixing faucet.

FIG. 3b shows an exploded view of a mixing faucet including a water saving unit, according to some embodiments of the invention.

FIG. 4a shows a cross section of a water saving unit in a first position, according to some embodiments of the invention.

FIG. 4b shows a cross section of the water saving unit of FIG. 4a in a second position, according to some embodiments of the invention.

FIG. 4c shows a cross section of the water saving unit of FIGS. 4a-b in a third position, according to some embodiments of the invention.

FIG. 5a shows a cross section of a thermostatic working unit in a first position, according to some embodiments of the invention.

FIG. 5b shows an isometric view of the thermostatic working unit of FIG. 5a in the state position, according to some embodiments of the invention.

FIG. 5c shows a cross section of the thermostatic working unit in a second position, according to some embodiments of the invention.

FIG. 5d shows an isometric view of the cross section of the thermostatic working unit of FIG. 5c in the second position, according to some embodiments of the invention.

### DETAILED DESCRIPTION OF PREFERRED EMBODIMENTS

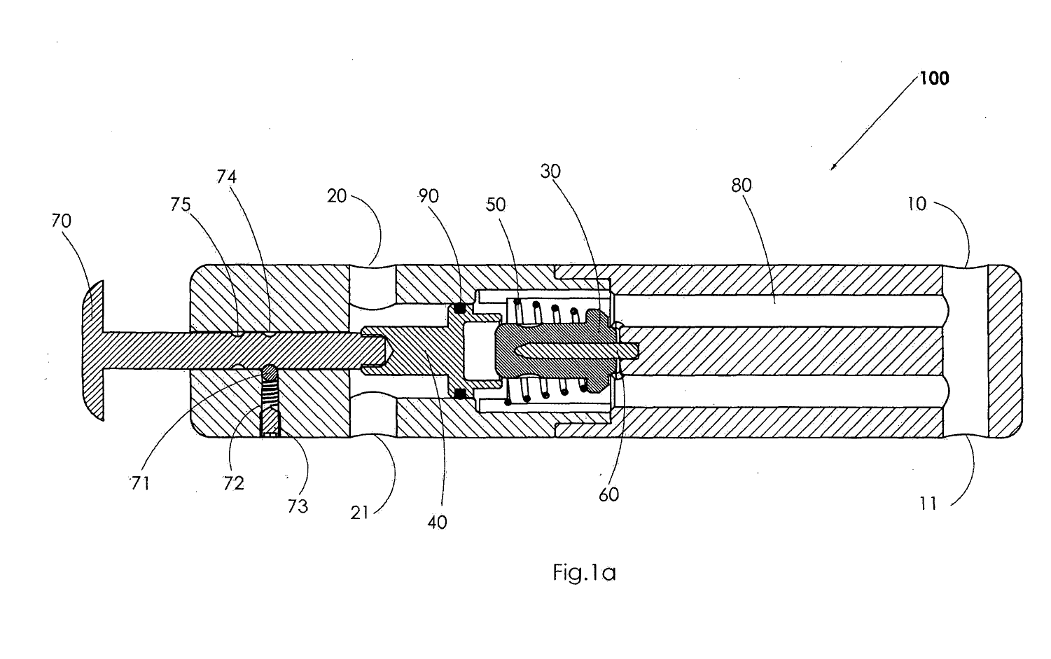

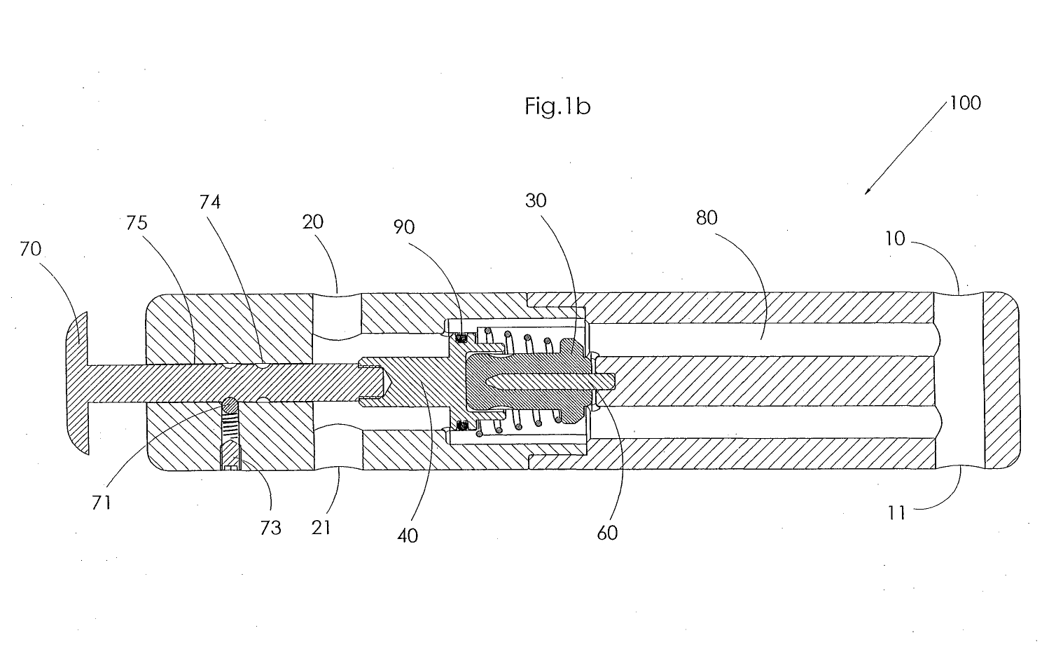

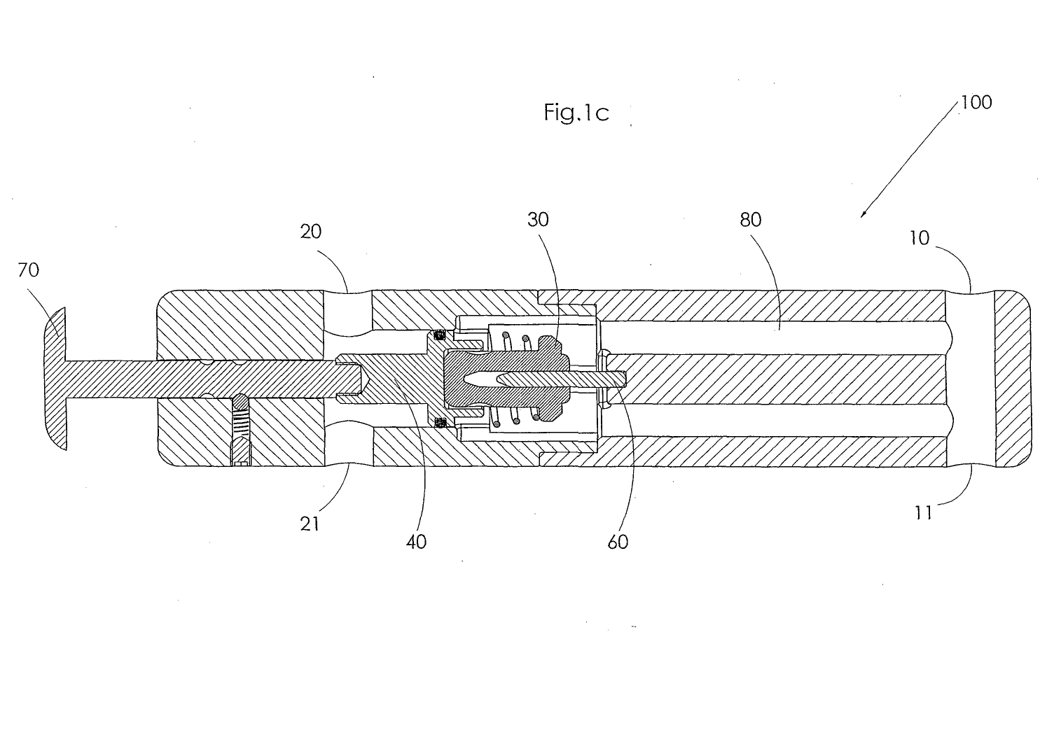

FIG. 1a shows a cross section of a water saving apparatus 100, set in its first position, according to embodiments of the invention. Apparatus 100 may be configured to be positioned between water supply lines, hot and cold (not shown) and a faucet (tap) (not shown). Water port 10 is connected to the cold water supply line and configured to receive cold water therefrom. Water port 10 is in fluid flow connection (for example, via a cavity) to port 11. Port 11 is connected to the faucet. Port 10 may also be in fluid flow connection with ports 20 and 21 depending on the position of valve 40. FIG. 1a shows water saving apparatus 100, set in its first position wherein valve 40 is in a closed position preventing flow of water between ports 20/21 and 10/11.

Water port 20 is connected to the hot water supply line. On the other side of the apparatus, water port 21 is connected to the faucet.

In this first position valve 40 is in its closed position, located in the (narrow) passage of cavity 80, effectively acting as a barrier and thus essentially blocking the flow of water from port 20 to port 10. Valve 40 may be any valve or any other device which can prevent the flow of water in cavity 80, which connects between port 20 and port 10. At this position mechanism 30 is at ambient temperature and it is closed, such that the pin 60 is fully retracted in mechanism 30.

In one of the embodiments mechanism 30 is a thermostatic working element which may also be referred to as a thermal pellet. In this embodiment when the temperature around the pellet increases, the material inside the pellet starts to expand, effectively extracting pin 60. In this embodiment, the mechanism 30 may be a wax pellet, a bimetal pellet or any other pellet or device which expands in reaction to heat, or any other mechanism which expands in reaction to the flow of water or the passing of time. Apparatus 100 further comprises a spring 50 located essentially around mechanism 30. In the first position, spring 50 is in a position for holding mechanism 30 in a closed position such that pin 60 is fully retracted inside mechanism 30. In this embodiment, the water pressure in the hot water supply line is greater than the water pressure in the cold water supply line, for reasons that will be described in relations to FIG. 1b. Higher water pressure in the hot water supply line may be achieved in a variety of ways such as attaching an auxiliary pump in the hot water supply line. In one embodiment the auxiliary pump is automatically activated in response to water flow in the hot water supply line, or in response to a drop in water pressure in the hot water supply line, or in response to a changing difference in the pressure between the hot water supply line and the cold water supply line. In one of the embodiments a seal 90, such as a rubber O-ring, may be added to valve 40, for effectively sealing the barrier between the flow of cold water and the flow of hot water. As shown valve 40 is connected to activator 70 which can shift valve 40 from its closed position to its open position. Activator 70 may be a button, as shown, a cord, a switch, a lever, a chain or any other activating mechanism capable of shifting valve 40 to its open position. In one embodiment, activator 70 has two circular cavities 74 and 75 carved around its axis for sustaining it in one of its two positions. As shown, activator 70 is sustained in the first position by a ball 71 pressed in the first cavity 74. The ball 71 may be pressed into place by a spring 72 which is sustained by a closing bolt 73.

FIG. 1b shows a cross section of water saving apparatus 100, set to its second position, according to an embodiment of the invention. The second position occurs after the activator 70 is shifted to its second position. The second position may be activated by the user, effectively allowing the user to decide when he requests warm water. In one embodiment, the activator 70 may be a button, and it is shifted to its second position by pressing. When activator 70 is shifted to its second position, water flow passage between port 20 and port 10 is obtained. This may be achieved for example, as follows: ball 71, which sustained the activator 70 in its first position, is pushed out and pressed back into the second cavity 75, to sustain the activator 70 in its second position. When activator 70 is shifted to its second position, valve 40 is shifted in channel 80, from its left narrow passage to its right wider passage, effectively opening the water passage between port 20 to port 10. Since the water pressure in the hot water supply line is greater than the water pressure in the cold water supply line, and since the faucet is closed and water cannot flow through ports 21 and 11, cold water from the hot water port 20 flows into the cold water port 10. While the cold water flows from the hot water supply line to the cold water supply line, the cold water, in the hot water supply line, is replaced by warmer water. The term “cold water” may include, according to some embodiments, water originated from the hot water supply line, which were cooled during a period of time (for example to ambient temperature). As the flow of water continues from water port 20 to water port 10 the temperature of the flowing water increases as heated water arrives from the hot water supply line. The increased temperature of the water heats the surrounding including mechanism 30.

FIG. 1c shows a cross section of water saving apparatus 100, set to its third position, according to an embodiment of the invention. In this position the warm water flowing from hot water supply line port 20 have heated mechanism 30 which is designed to extract pin 60 upon warming. Heated mechanism 30 has extracted pin 60, effectively closing the passage in channel 80 by shifting valve 40 to its closed position, blocking the flow of water from port 20 to port 10. In one embodiment when valve 40 is shifted, activator 70 is also shifted outwards, effectively indicating to the user that the water in the hot water supply line is warm. At this point when the user may open the hot water knob in the faucet, and the warm water flows directly from the hot water supply line through port 20 and through the hot water port 21 to the hot water outlet of the opened faucet.

In one of the embodiments the described apparatus of FIG. 1a to 1c, is connected between the hot and cold water supply lines respectively, far from the faucet, instead of connecting the apparatus to the faucet directly. In one embodiment the described apparatus of FIG. 1a to 1c is hidden from the sight of the customer and may be operated using a chain or lever connected to activator 70, or instead of activator 70, for the user to operate.

In one of the embodiments the mechanism 30 described in FIGS. 1b and 1c is a timer pellet. When the activator 70 is pressed, as shown in FIG. 1b, and water starts flowing from hot water supply line port 20 to cold water supply line port 10, the mechanism 30 is closed for a preset time such as 1 minute. After the preset time expires, mechanism 30 extracts pin 60, as shown in FIG. 1c, and shifts valve 40 to its closed position, which acts again as a barrier blocking the flow of water from port 20 to port 10. In another embodiment the described mechanism 30 is a rotary piston measuring the flow of water. Once a preset amount of water has flowed in channel 80, mechanism 30 extracts pin 60, effectively shifting piston 40 to its closed position as described above.

In one of the embodiments the described apparatus is used with a Thermal Tap, where the apparatus may be fixed between the water supply lines and the Thermal Tap or may be implemented in the Thermal Tap for reserving the cooled water from the hot water supply line.

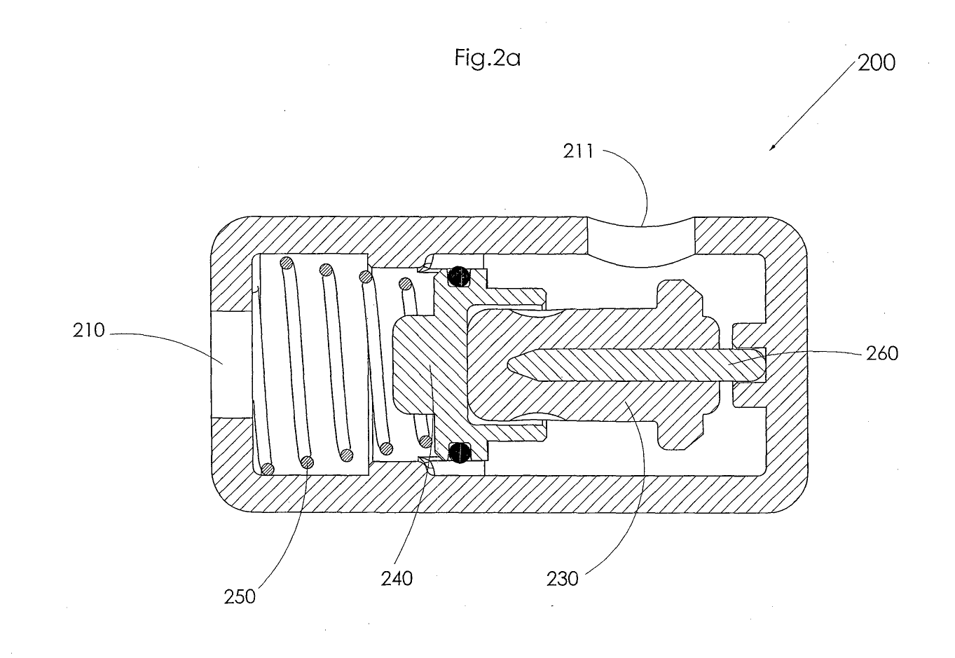

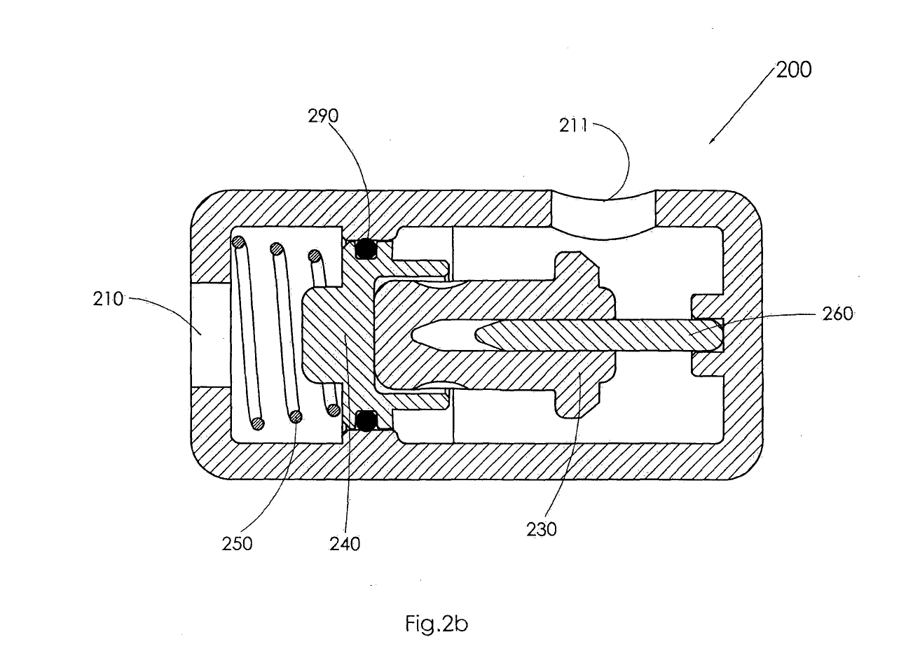

FIG. 2a shows a cross section of water saving apparatus 200, set in its first position, configured to continuously circulate hot water systems, according to another embodiment of the invention. In these systems, the pipes leading from the hot water heater are arranged in a loop, passing near each tap, with a return pipe to the hot water heater. A pump is inserted in the loop to keep hot water flowing through the loop, thereby keeping the pipes and the water in them at a high temperature. In this embodiment the depicted apparatus is intended to be connected in the hot water supply line loop (not shown), where the water flow is designed to flow from water outlet 210 to water outlet 211. In one embodiment the apparatus's outlets are covered by gaskets and nuts which can be tightly screwed on the water supply line. In this first position valve 240 is in its open position, allowing water to flow from water outlet 210 to water outlet 211. At this position the mechanism 230 has an ambient temperature and therefore it is closed, meaning that the pin 260 is retracted maximally in mechanism 230. When the temperature around mechanism 230 increases, the material inside the mechanism 230 will start to expand, effectively extracting pin 600. The mechanism 230 may be a wax pellet, a metal pellet or any other pellet or device described in relations to FIGS. 1a-c. In one of the embodiments the pellet is designed to achieve its full expansion at a temperature of at least 35° C. In this position spring 500 task is to hold the pellet 300 closed with pin 260 squeezed inside.

FIG. 2b shows a cross section of the water saving apparatus of FIG. 2a, set in its second position, intended for continuously circulating hot water systems. In this position the warm water that had flowed from outlet 210 to outlet 211 have heated the pellet 300 which is designed to extract pin 260 upon warming. The heated pellet 300 has extracted pin 260, effectively closing the passage and stopping the water flow by shifting valve 240 to its closed position, which acts as a barrier between outlet 210 and outlet 211. Thus when the water is warm enough the circulating stops, effectively saving energy. However, when the water cools down and the pellet 230 cools down to its close position, the apparatus is switched to its first position and the hot water circulation continues. In one of the embodiments a seal 290, such as a rubber O-ring, may be added to valve 240, for effectively sealing the barrier and stopping the water flow.

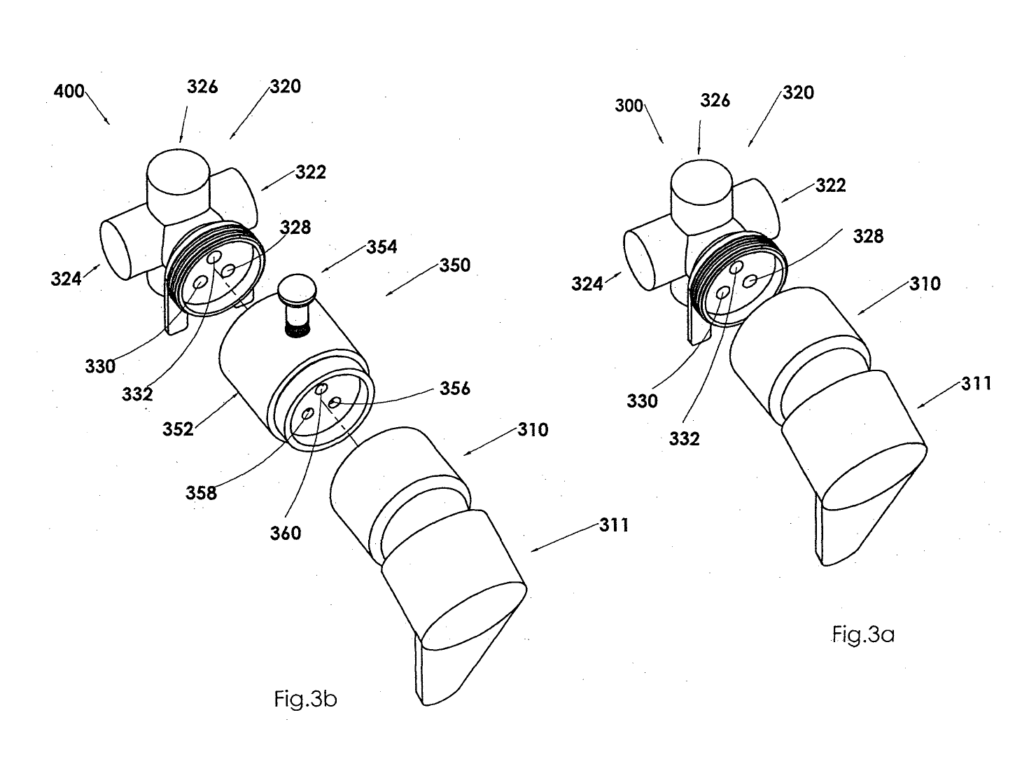

Reference is now made to FIG. 3a, which shows an exploded view of a typical mixing faucet 300 and to FIG. 3b, which shows an exploded view of a mixing faucet 400 which includes a water saving unit 350, according to some embodiments of the invention.

Faucets 300 and 400 both include a mixing valve 310, controlled by handle 311, and a faucet base 320. Mixing valve 310 is configured to allow a user to adjust (via handle 311) the water temperature and the amount of mixed water exiting the faucet (by mixing hot/cold water and regulating the flow of mixed water).

Faucet base 320 includes port 322 connected to the cold water supply line, port 324 connected to the hot water supply line and port 326 which is connected to the faucet outlet such as a shower head etc. Faucet base 320 further includes port 328 configured to pass cold water from the cold water supply line to mixing valve 310, port 330 configured to pass hot water from the hot water supply line to mixing valve 310 and port 332 configured to pass mixed water from mixing valve to the faucet outlet such as shower outlet etc.

Mixing valve 310 of faucet 300 (FIG. 3a) is connected directly to faucet base 320.

Mixing valve 310 of faucet 400 (FIG. 3b) is connected to faucet base 320 through water saving unit 350. Water saving unit 350 comprises a main body 352 and an activator 354 and is configure to connect on one end to faucet base 320 and on its other end to mixing valve 310. Water saving unit 350 further includes port 356 configured to pass cold water from cold water supply line to mixing valve 310, port 358 configured to pass hot water from hot water supply line to mixing valve and port 360 configured to pass mixed water from mixing valve 310 to the faucet outlet such as shower outlet etc.

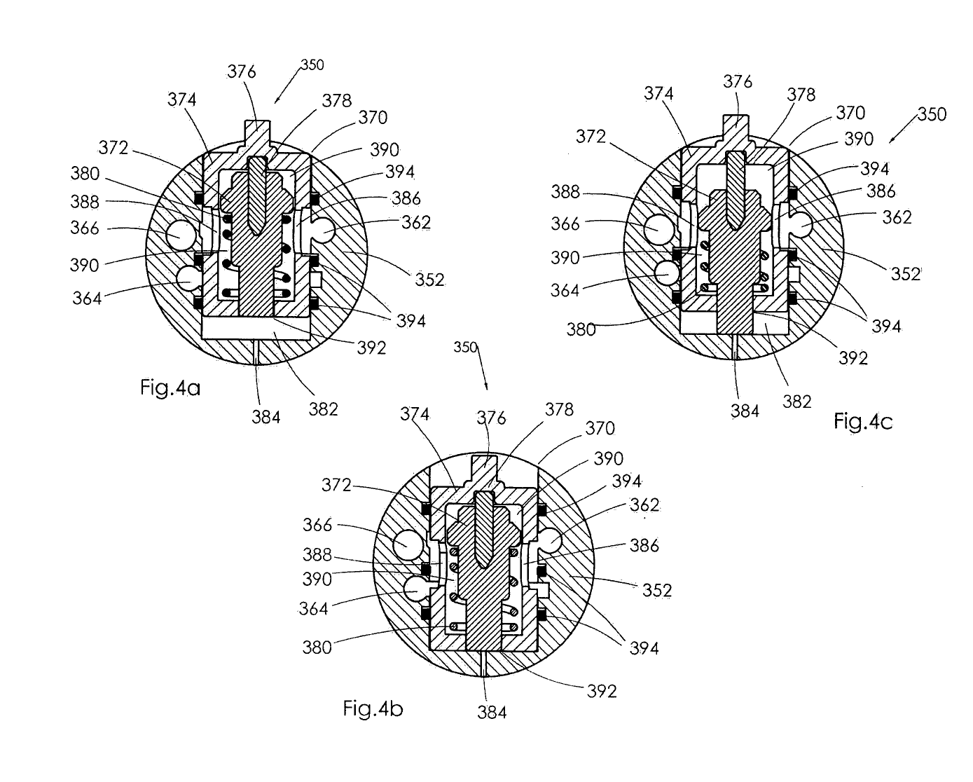

Reference is now made to FIGS. 4a-4c, which show cross sections of a water saving unit 350 in first, second and third positions, respectively, according to some embodiments of the invention. As seen in FIGS. 4a-4c, water saving unit 350 includes valve assembly 370 (in this case, a sliding valve assembly is described, but other valve assemblies are also included under the scope of this invention, for example, spiral valve assemblies, rotating valve assemblies or any other type of valve assembly), cold water cavity 362, hot water cavity 364 and mixed water cavity 366.

Cold water cavity 362 of water saving unit 350 is connected on one side to port 328 of faucet base 320 and on another side to port 356. Hot water cavity 364 water saving unit 350 is connected on one side to port 330 of faucet base 320 and on another side to port 358. Cold water cavity 362 and hot water cavity 364 may be in water flow connection with each other or separated from each other depending on the position of water saving unit 350, or more specifically, the position of valve assembly 370, as described hereinbelow.

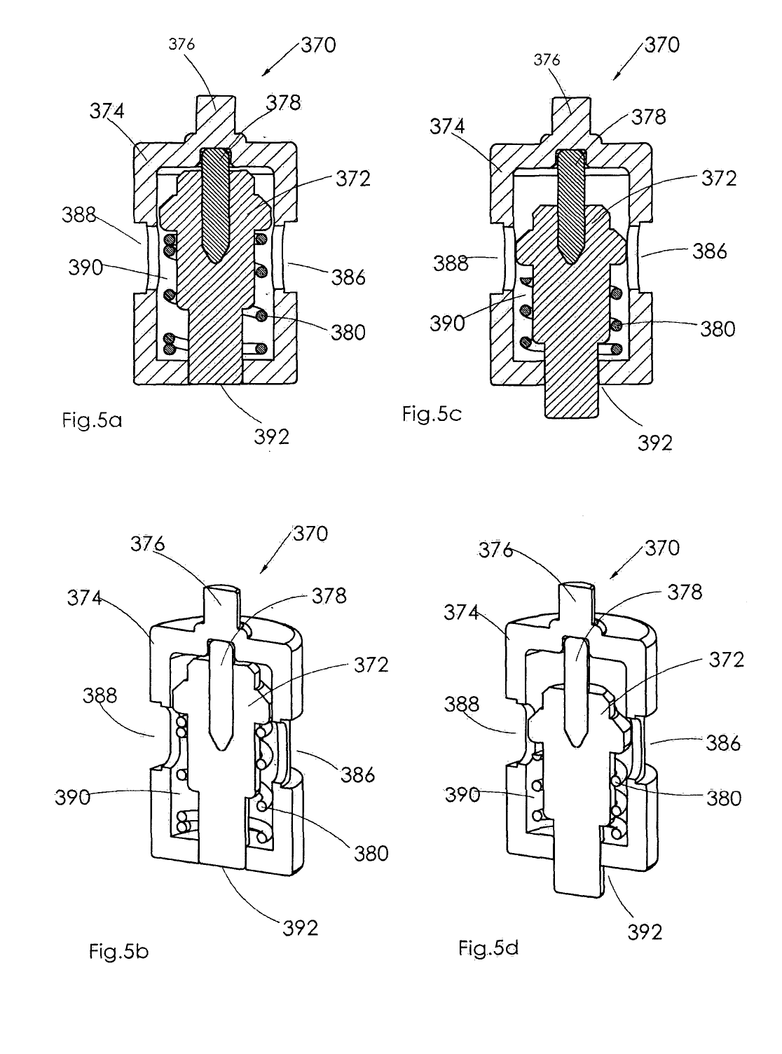

Reference is also made to FIG. 5a, which shows a cross section of valve assembly 370, in a first state (pin 378 is fully retracted in thermostatic working element 372), according to some embodiments of the invention, to FIG. 5b, which shows an isometric view of the cross section of valve assembly 370 in the first state, according to some embodiments of the invention, to FIG. 5c, which shows a cross section of the valve assembly 370 in a second state (pin 378 extracted from thermostatic working element 372), according to some embodiments of the invention and to FIG. 5d, which shows an isometric view of the cross section of the valve assembly 370 in the second position, according to some embodiments of the invention.

Valve assembly 370 is located within body 352 of saving unit 350 and comprises thermostatic working element, 372, valve body 374, spring 380 and activator interface 376 (connected to activator 354 as seen in FIG. 3b). Thermostatic working element 372 includes a pin 378 inserted (retracted) within thermostatic working element 372 to an extent which depends on the surrounding temperature. Spring 380 is located essentially around thermostatic working element 372, between the thermostatic working element 372 and valve body 374, for example, in cavity 390.

Valve 374 has an essentially cylindrical shape and includes one or more openings, such as an opening 386, an opening 388 (there may be more openings) (also seen in FIGS. 4a-c) and a bottom opening 392. At its top part, valve 374 has or connected to activator interface 376 extending therefrom.

When valve assembly 370 is in a first state (as shown in FIGS. 5a-b), pin 378 is maximally retracted in thermostatic working element 372 and the bottom part of thermostatic working element 372 is positioned within bottom opening 392 of valve body 374, but does not protrude therefrom. When thermostatic working element 372 is heated pin 378 is extracted out from thermostatic working element 372 and pushes valve assembly 370 to a second position (as shown in FIGS. 5c-d).

FIG. 4a, shows a cross section of a water saving unit 350 in first positions, in which valve assembly 370 is in a first position (as shown in FIGS. 5a-b),

In first position (FIG. 4a) valve assembly 370 is in its closed position, effectively acting as a barrier and thus essentially blocking the flow of water from hot water cavity 364 to cold water cavity 362. In this first position (FIG. 4a) valve assembly 370 is at ambient temperature and pin 378 is maximally retracted in thermostatic working element 372. In this first position, valve 374 is blocking hot water cavity 364 thus blocking water flow passage between hot water cavity 364 and cold water cavity 362 and thus preventing flow of water from hot water cavity 364 to cold water cavity 362. In this first position, a void 382 remains between thermostatic working element 372 and main body 352 allowing room for valve assembly 370 travel to second position.

Second position (FIG. 4b) of water saving unit 350 occurs after the activator interface 376 is shifted to its second position. In the second position of water saving unit 350, thermostatic working element 372 is in a first state (as shown in FIGS. 5a-b).

The second position may be activated by the user, effectively allowing the user to decide when he requests warm water. In one embodiment, the activator interface 376 may be a button, and it is shifted to its second position by pressing. When activator interface 376 is shifted to its second position, water flow passage between hot water cavity 364 to cold water cavity 362 is obtained. When activator interface 376 is shifted to its second position, activator interface 376 is pushed towards the center of main body 352, valve 374 shifts towards void 382 (releasing locked air from vent 384) and occupying it. This shift of valve 374 also connects hot water cavity 364 (through opening 386) and cold water cavity 362 (through opening 388) through cavity 390 located essentially between thermostatic working element 372 and valve body 374 allowing water flow passage between hot water cavity 364 to cold water cavity 362.

Since the water pressure in the hot water supply line is greater than the water pressure in the cold water supply line, cold water (not yet warmed) from the hot water cavity 364 flows into the cold water cavity 362 (and on to through port 328 of faucet base 320 and to the cold water supply line). While the cold water flows from the hot water supply line to the cold water supply line, the cold water, in the hot water supply line, is replaced by warmer water. The term “cold water” include, according to some embodiments, water originated from the hot water supply line, which were cooled during a period of time (for example to ambient temperature). As the flow of water continues from hot water cavity 364 flows into the cold water cavity 362 the temperature of the flowing water increases as heated water arrives from the hot water supply line. The increased temperature of the water heats its surrounding including thermostatic working element 372 and water saving unit 350 is shifted into its third position (FIG. 4c), in which thermostatic working element 372 is in its first state (as shown in FIGS. 5a-b).

As a result of heating of thermostatic working element 372, pin 378 is extracted out from working element 372 and pushes against valve 374 which in turn pushes valve 374 outwardly towards the periphery of main body 352. When valve 374 is pushed outwardly towards the periphery of main body 352, valve 374 blocks hot water cavity 364 thus blocking water flow passage between hot water cavity 364 and cold water cavity 362. In addition, when valve 374 is pushed outwardly towards the periphery of main body 352, a bottom end of thermostatic working element 372 (the end opposing to the end which accommodates pin 378) is presses through bottom opening 392 in valve body 374 and into void 382. Further, when valve 374 is pushed outwardly towards the periphery of main body 352 activator interface 376 is pushed out from main body 352. When activator interface 376 is pushed out from main body 352, activator 354 is also pushed out from water saving unit 350 providing indication to the user that faucet 400 is ready to provide hot water.

The third position of water saving unit 350 is maintained until the temperature of the water in cavity 390 decreases, cooling thermostatic working element 372, allowing pin 378 to be retracted back into thermostatic working element 372 by the stretching of spring 380. Thus water saving unit 350 is shifted back into its first position (FIG. 4a).

In one of the embodiments seals 394, such as a rubber O-rings, are located between main body 352 and valve assembly 370, for effectively blocking water flow passage between hot water cavity 364 and cold water cavity 362 when the saving unit 350 is in first and third positions.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the invention or exceeding the scope of claims.

What we claim is:

1. A water saving apparatus configured for purging water from a hot water supply line into a cold water supply line comprising:
a hot water cavity connected to said hot water supply line for allowing flow of water from said hot water supply line to said first cavity;
a cold water cavity connected to said cold water supply line for allowing flow of water from said cold water supply line to said cold cavity and from said hot water cavity to said cold water supply line;
a valve configured to block the flow of water between said hot water cavity and said cold water cavity in a first position thereof and to allow the flow of water from said hot water cavity through said cold water cavity and to said cold water supply line in a second position thereof for purging water from said hot water supply line;
a mechanism configured to, directly or indirectly, shift said valve from said first position to said second position; and
an activator configured to shift said valve from said first position to said second position per demand.

2. An apparatus according to claim 1, wherein said activator is configured for manual operation.

3. An apparatus according to claim 1, wherein said mechanism comprises a thermal mechanism.

4. An apparatus according to claim 1, wherein said thermal mechanism is adapted to shift said valve from said second position back to said first position when the temperature of the water increases to a predetermined value, thereby the flow of water from said hot water cavity through said cold water cavity and to said cold water supply line is stopped.

5. An apparatus according to claim 1, wherein said mechanism comprises a timer.

6. An apparatus according to claim 1, wherein said activator is selected from a group consisting of: a button, a cord, a switch, a lever and a chain.

7. An apparatus according to claim 1, wherein said valve is essentially in a cylindrical shape and wherein said mechanism is a thermostatic working element, said valve is configured to change its position upon a change of temperature of said thermostatic working element and upon activation of said activator by a user, such that:
in a first position of said apparatus, said valve blocks water flow between said hot water cavity and said cold water cavity; and
upon activation of said activator, in a second position of said apparatus, said valve is positioned to allow water flow between said hot water cavity and said cold water cavity and thus allowing bypassing of water from said hot water supply line to said cold water supply line until water temperature increases to a predetermined value and said apparatus is shifted to a third position, wherein said valve blocks water flow between said hot water cavity and said cold water cavity and the water bypassing is stopped.

8. An apparatus according to claim 1, wherein said valve is essentially in a hollow cylindrical shape and wherein said mechanism is a thermostatic working element and is located inside said valve, said valve comprises one or more openings, said valve and said thermostatic working element are configured to move with respect to one another upon activation of said activator and upon a change of temperature of said thermostatic working element, such that:
in a first position of said apparatus, said valve blocks water flow between said hot water cavity and said cold water cavity; and
in a second position of said apparatus and upon activation of said activator, said valve is positioned with respect to thermostatic working element to allow water flow, through said one ore more openings thereof, between said hot water cavity and said cold water cavity and thus allowing bypassing of water from said hot water supply line to said cold water supply line until water temperature increases to a predetermined value and said apparatus is shifted to a third position, wherein said valve blocks water flow between said hot water cavity and said cold water cavity and the water bypassing is stopped.

9. An apparatus according to claim 8, wherein said third position is achieved by the extraction of a pin from said thermostatic working element.

10. An apparatus according to claim 9, wherein upon a decrease of water temperature said pin is retracted back inside said thermostatic working element and said apparatus is configured to return to said first position.

11. An apparatus according to claim 10, further comprising a spring configured to starch and facilitate the return of said apparatus to said first position.

12. A water saving faucet comprising:
a water saving apparatus for purging water from a hot water supply line into a cold water supply line, the apparatus comprises:
a hot water cavity connected to said hot water supply line for allowing flow of water from said hot water supply line to said first cavity;
a cold water cavity connected to said cold water supply line for allowing flow of water from said cold water supply line to said cold cavity and from said hot water cavity to said cold water supply line;
a valve configured to block the flow of water between said hot water cavity and said cold water cavity in a first position thereof and to allow the flow of water from said hot water cavity through said cold water cavity and to said cold water supply line in a second position thereof for purging water from said hot water supply line;
a mechanism configured to, directly or indirectly, shift said valve from said first position to said second position; and
an activator configured to operate said valve per demand; and
a mixing valve controlled by a handle, said mixing valve is configured to allow a user to adjust, by said handle, the water temperature and the amount of mixed water exiting the faucet.

13. A faucet according to claim 12, wherein said activator is configured for manual operation.

14. A faucet according to claim 12, wherein said mechanism comprises a thermal mechanism.

15. A faucet according to claim 12, wherein said thermal mechanism is adapted to shift said valve from said second position back to said first position when the temperature of the water increases to a predetermined value, thereby the flow of water from said hot water cavity through said cold water cavity and to said cold water supply line is stopped.

16. A faucet according to claim 12, wherein said mechanism comprises a timer.

17. A faucet according to claim 12, wherein said activator is selected from a group consisting of: a button, a cord, a switch, a lever and a chain.

18. A faucet according to claim 12, wherein said valve is essentially in a cylindrical shape and wherein said mechanism is a thermostatic working element, said valve is configured to change its position upon a change of temperature of said thermostatic working element and upon activation of said activator by a user, such that:
in a first position of said apparatus, said valve blocks water flow between said hot water cavity and said cold water cavity; and
upon activation of said activator, in a second position of said apparatus, said valve is positioned to allow water flow between said hot water cavity and said cold water cavity and thus allowing bypassing of water from said hot water supply line to said cold water supply line until water temperature increases to a predetermined value and said apparatus is shifted to
a third position, wherein said valve blocks water flow between said hot water cavity and said cold water cavity and the water bypassing is stopped.

19. A faucet according to claim 12, wherein said valve is essentially in a hollow cylindrical shape and wherein said mechanism is a thermostatic working element and is located inside said valve, said valve comprises one or more openings, said valve and said thermostatic working element are configured to move with respect to one another upon activation of said activator and upon a change of temperature of said thermostatic working element, such that:
in a first position of said apparatus, said valve blocks water flow between said hot water cavity and said cold water cavity; and
in a second position of said apparatus and upon activation of said activator, said valve is positioned with respect to thermostatic working element to allow water flow, through said one or more openings thereof, between said hot water cavity and said cold water cavity and thus allowing bypassing of water from said hot water supply line to said cold water supply line until water temperature increases to a predetermined value and said apparatus is shifted to
a third position, wherein said valve blocks water flow between said hot water cavity and said cold water cavity and the water bypassing is stopped.

20. A faucet according to claim 19, wherein said third position is achieved by the extraction of a pin from said thermostatic working element.

21. A faucet according to claim 20, wherein upon a decrease of water temperature said pin is retracted back inside said thermostatic working element and said apparatus is configured to return to said first position.

22. A faucet according to claim 21, further comprising a spring configured to starch and facilitate the return of said apparatus to said first position.

23. A water saving system comprising:
a water saving apparatus for purging water from a hot water supply line into a cold water supply line, the apparatus comprises:
a hot water cavity connected to said hot water supply line for allowing flow of water from said hot water supply line to said first cavity;
a cold water cavity connected to said cold water supply line for allowing flow of water from said cold water supply line to said cold cavity and from said hot water cavity to said cold water supply line;
a valve configured to block the flow of water between said hot water cavity and said cold water cavity in a first position thereof and to allow the flow of water from said hot water cavity through said cold water cavity and to said cold water supply line in a second position thereof for purging water from said hot water supply line;
a mechanism configured to, directly or indirectly, shift said valve from said first position to said second position; and
a pump configured to increase hot water pressure in said hot water supply line upon indication of a decrease, below a predetermined value, in a differential pressure between said hot water supply line and said cold water supply line.
